(19) United States
(12) Patent Application Publication
(10) Pub. No.: US 2026/0301091 A1
(43) Pub. Date: Oct. 1, 2026

(54) ICT EDUCATION SUPPORT DEVICE, ICT EDUCATION SUPPORT METHOD, AND RECORDING MEDIUM

(71) Applicant: NEC Corporation, Tokyo (JP)

(72) Inventors: Kengo UEMITSU, Tokyo (JP); Tadasuke Daikuhara, Tokyo (JP); Takashi Komiya, Tokyo (JP); Hideo Kojima, Tokyo (JP); Hisashi Negishi, Tokyo (JP)

(73) Assignee: NEC Corporation, Tokyo (JP)

(21) Appl. No.: 19/434,241

(22) Filed: Dec. 29, 2025

(30) Foreign Application Priority Data
Mar. 28, 2025 (JP) 2025-054981

(51) Int. Cl. G06Q 50/20; G09B 5/14

(52) U.S. Cl. CPC G06Q 50/205; G09B 5/14

(57) ABSTRACT

An ICT education support device acquires information according to a proficiency level about an ICT of a user of an ICT use environment, determines an ICT knowledge level of the user using the acquired information, provides the ICT use environment according to the ICT knowledge level of the user to the user, and transmits data to be submitted created by the user to an educational institution in the ICT use environment provided to the user.

### TECHNICAL FIELD

The present disclosure relates to an Information and Communication Technology (ICT) education support device, an ICT education support method, and a recording medium, and more particularly, to an ICT education support device, an ICT education support method, and a recording medium that support AI education by an educational institution (school or the like).

### BACKGROUND ART

In recent years, in the education industry, a large number of educational institutions (including elementary, junior high, and high schools, universities, and technical schools) have provided data science and artificial intelligence (AI) related courses.

In a method described in JP 2022-97492 A, a task set is provided to a user, using an artificial intelligence module. Using a performance parameter related to execution of a task by the user, as an input to a machine learning model, it is determined whether a skill level of the user satisfies a skill threshold.

Moreover, JP 2022-97492 A describes that, when setting update for the artificial intelligence module is acquired from the user and it is determined that the skill level of the user satisfies the skill threshold, a subsequent task set is selected from among training or a plurality of tasks of the user and the artificial intelligence module is updated.

### SUMMARY

A depth of understanding and a knowledge amount about an ICT differ for each student. However, in many educational institutions, even if there are educational programs, know-how and human resources related to AI-related education are particularly insufficient. Therefore, the educational institution cannot provide sufficiently satisfactory education, for a user of an educational service. In a field of education, there is a demand for a technology for supporting ICT-related education including AI.

The present disclosure has been made in view of the above problems, and an object of the present disclosure is to support ICT-related education, by providing an ICT use environment in which a user of an educational service can easily learn an ICT-related technology.

An ICT education support device according to one aspect of the present disclosure includes acquisition means for acquiring information according to a proficiency level about an ICT of a user of an ICT use environment, determination means for determining an ICT knowledge level of the user, using the acquired information, provision means for providing the ICT use environment according to the ICT knowledge level of the user to the user, and transmission means for transmitting data to be submitted created by the user to an educational institution, in the ICT use environment provided to the user.

An ICT education support method executed by a computer according to one aspect of the present disclosure, includes a process for acquiring information according to a proficiency level about an ICT of a user of an ICT use environment, a process for determining an ICT knowledge level of the user, using the acquired information, a process for providing the ICT use environment according to the ICT knowledge level of the user to the user, and a process for transmitting data to be submitted created by the user to an educational institution, in the ICT use environment provided to the user.

A recording medium according to one aspect of the present disclosure stores a program for causing a computer to execute processing for acquiring information according to a proficiency level about an ICT of a user of an ICT use environment, processing for determining an ICT knowledge level of the user, using the acquired information, processing for providing the ICT use environment according to the ICT knowledge level of the user to the user, and processing for transmitting data to be submitted created by the user to an educational institution, in the ICT use environment provided to the user.

According to one aspect of the present disclosure, it is possible to support ICT-related education, by providing an ICT use environment in which a user of an educational service can easily learn an ICT-related technology.

### BRIEF DESCRIPTION OF THE DRAWINGS

FIG. 1 is a diagram schematically illustrating an example of a system including an ICT education support device according to one example embodiment;

FIG. 2 is a block diagram illustrating a configuration of the ICT education support device according to one example embodiment;

FIG. 3 is a flowchart illustrating an operation of the ICT education support device according to one example embodiment;

FIG. 4 is a block diagram illustrating the configuration of the ICT education support device according to one example embodiment;

FIG. 5 is a flowchart illustrating the operation of the ICT education support device according to one example embodiment; and

FIG. 6 is a diagram illustrating an example of a hardware configuration of the ICT education support device according to one example embodiment.

### EXAMPLE EMBODIMENT

Hereinafter, some example embodiments of the present disclosure will be described with reference to the drawings.

### System 1

First, an example of a system 1 including any one of ICT education support devices 10 and 20 according to first and second example embodiments to be described below will be schematically described.

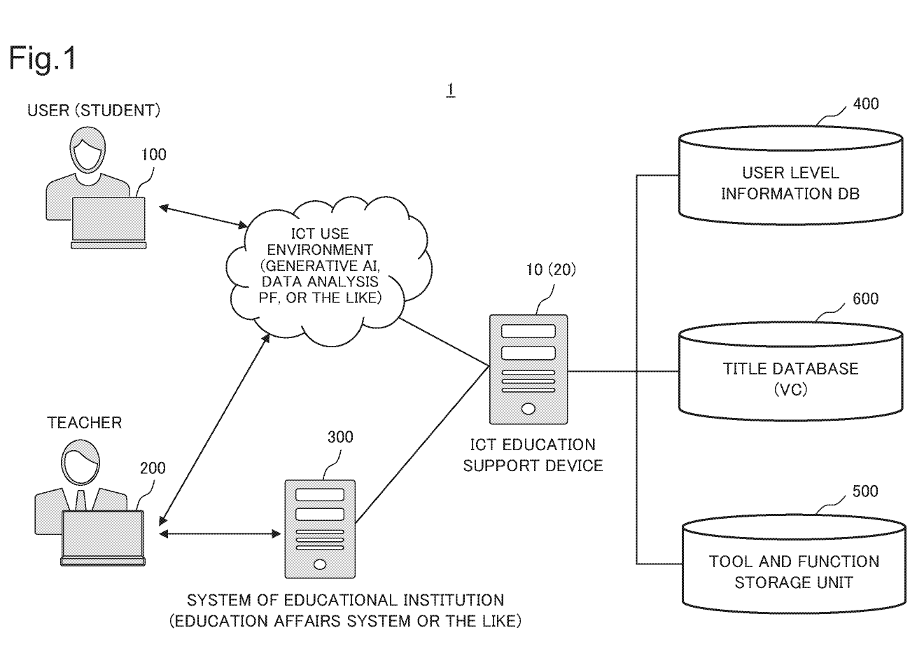

As illustrated in FIG. 1, the system 1 includes the ICT education support device 10 (20), a user’s terminal 100, and a teacher terminal 200. Here, the “ICT education support device 10 (20)” means “any one of the ICT education support devices 10 and 20 according to the first and second example embodiments”. In the present disclosure, the “user” means a user (student, participant, or the like) of an educational service, in a broad sense. In a narrow sense, the “user” indicates a person who uses an ICT use environment in the present disclosure. Typically, the user is a student belonging to an educational institution (school or the like), but is not limited thereto. The user learns ICT-related technologies, through the ICT use environment provided by the ICT education support device 10 (20).

Each of the user’s terminal 100 and the teacher terminal 200 is an information communication device such as a smartphone, a tablet terminal, or a mobile notebook PC. An education affairs system 300 connected to the teacher terminal 200 cooperates with a Learning Management System (LMS) (not illustrated). Here, the learning management system is an IT tool that manages teaching materials and learning situations in e-learning. The ICT education support device 10 (20) may cooperate with the learning management system (not illustrated) or an ID management system, via the education affairs system 300 or directly.

Moreover, the system 1 further includes a user level information DB 400, a tool and function storage unit 500, and a title database 600.

The ICT education support device 10 (20) acquires information according to a proficiency level about an ICT of the user of the ICT use environment. Here, the ICT use environment is an online education (learning) environment in which the user of the educational service can freely use and experience advanced ICT-related technologies of generative AI, data analysis software, or the like. As will be described later, a tool and a function for the ICT use environment are provided to the user. The ICT use environment may have different accessible range between a student account and a teacher account. In the teacher account, a use history of the ICT use environment or an update history (to be described later) of data to be submitted by the student account can be confirmed, with a date and time when the ICT use environment has been used.

The information according to the proficiency level about the ICT of the user of the ICT use environment (hereinafter, proficiency level information) is information indicating how much the user of the ICT use environment knows about the ICT. In one example, the proficiency level information includes information indicating a completion status of an ICT-related course (including AI related course, mathematical related course, and data science course) of the user. In another example, the proficiency level information includes information indicating a grade of the user (for example, test result) in the ICT-related course or evaluation from an academic advisor. In still another example, the proficiency level information includes a use time of the ICT use environment by the user. In the present disclosure, the “use time” includes a time period from a time when the user logs in to the ICT use environment to a time when the user logs out. Specifically, the use time means an elapsed time from a time point when the user accesses the ICT use environment and logs in through authentication to a time point when the user logs out or automatic log-out caused by no operation for a certain period. In yet another example, the proficiency level information includes an access log of the user to the ICT use environment.

The proficiency level information is not limited to the above as long as the information is information related to an ICT knowledge level of the user. In the present disclosure, the ICT knowledge level is an index indicating a depth of understanding or a knowledge amount regarding the Information and Communication Technology (ICT) of the user. The ICT education support device 10 (20) can refer to the proficiency level information as described above, from the cooperative education affairs system 300 or the cooperative learning management system (not illustrated).

When determining the ICT knowledge level of the user, using the acquired proficiency level information, the ICT education support device 10 (20) stores information indicating the ICT knowledge level associated with an account of the user, in the user level information DB 400. Then, the ICT education support device 10 (20) provides the ICT use environment according to the ICT knowledge level of the user, to the user. For example, the ICT education support device 10 (20) may provide the ICT use environment to the user, as a part of an educational program by a learning institution.

The ICT education support device 10 (20) transmits the data to be submitted created by the user to an educational institution, in the ICT use environment provided to the user. Here, the data to be submitted includes various forms of data such as documents, data analysis results, images, voice, program codes, graduation thesis, and various other reports. For example, the ICT education support device 10 (20) transmits data of a report created by the user (example of data to be submitted) to a system of the educational institution or the teacher terminal 200, in the ICT use environment.

Details of the configuration of the ICT education support device 10 (20) will be described later in the description of the first and second example embodiments.

The user level information DB 400 stores the information indicating the ICT knowledge level of the user, in association with the account of the user. The account of the user is issued by an application of the user or registration by a staff member of an educational institution. The account of the user is related to an ID (student ID number) of the user saved in the education affairs system 300 or the cooperative ID management system (not illustrated) on a one-to-one basis.

Moreover, the user level information DB 400 may store information regarding an evaluation value acquired by the user so far. For example, the evaluation value of the user is added each time when the user achieves specific achievement (for example, login to ICT use environment or use of computer program) or a goal (for example, submission of assignments or reports), and when the evaluation value of the user exceeds a threshold, the ICT knowledge level of the user increases by one point.

The tool and function storage unit 500 stores tools and functions (for example, library, deep learning framework, dataset, AI model, data analysis platform, editor, image editing software, Graphical User Interface (GUI), and plug-in) provided to the user in the ICT use environment. The tool and function storage unit 500 may further store the information regarding the ICT-related course provided to the user, for example, moving image content or digital teaching materials.

The title database 600 stores Verifiable digital certificate VCs (verifiable digital certificate) that are certified for the user, by the ICT education support device 10 (20). Here, the verifiable credentials VCs are digital certificates in which an academic background, a career, an identity, a skill, or the like of the user is guaranteed (certified) by a reliable institution. For example, the title database 600 stores a certificate indicating that the user has a certificate certified by a public institution, a private organization, a company, a school, or a voluntary organization.

### First Example Embodiment

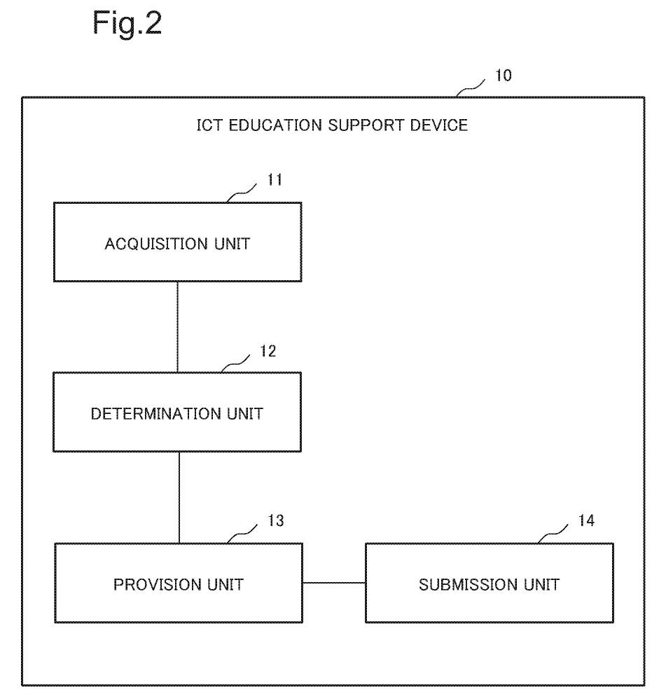

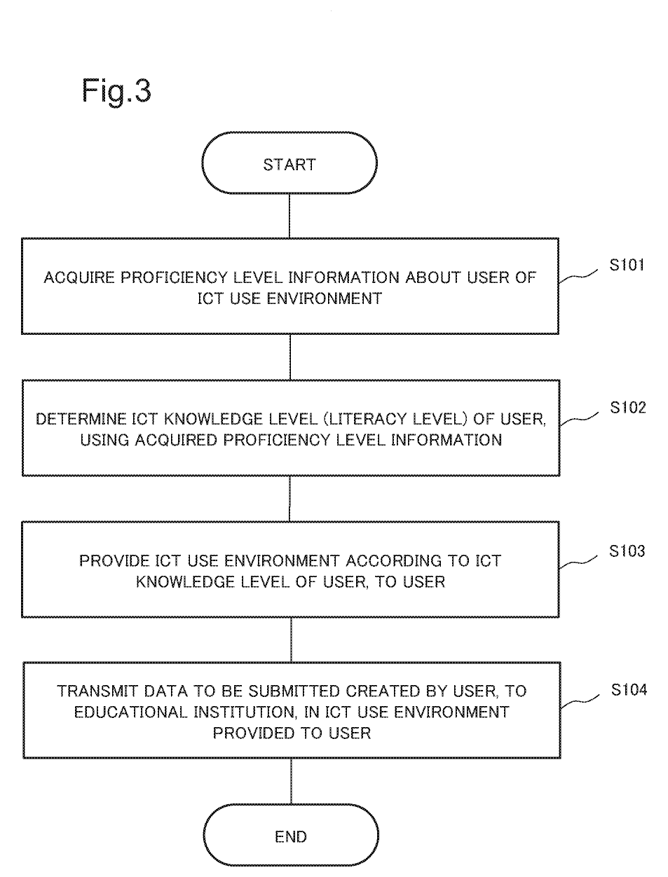

A first example embodiment will be described with reference to FIGS. 2 and 3.

### Configuration of ICT Education Support Device 10

FIG. 2 is a block diagram illustrating a configuration of an ICT education support device 10 according to the first example embodiment. As illustrated in FIG. 2, the ICT education support device 10 includes an acquisition unit 11, a determination unit 12, a provision unit 13, and a transmission unit 14.

The acquisition unit 11 acquires information according to a proficiency level about an ICT of a user of an ICT use environment. The acquisition unit 11 is an example of acquisition means.

For example, the acquisition unit 11 acquires identification information of the user (for example, account of user), from a user’s terminal 100 (FIG. 1). The acquisition unit 11 acquires proficiency level information, from the user’s terminal 100 (FIG. 1), an education affairs system 300 of an educational institution (FIG. 1), or a cooperative learning management system (not illustrated), using the acquired identification information of the user. In one example, the proficiency level information includes information indicating a completion status of an ICT-related course of the user. In another example, the proficiency level information includes a use time and an access log of the ICT use environment by the user.

The acquisition unit 11 outputs the acquired proficiency level information to the determination unit 12.

The determination unit 12 determines an ICT knowledge level (literacy level) of the user, using the proficiency level information. The determination unit 12 is an example of determination means.

For example, the determination unit 12 acquires the proficiency level information from the acquisition unit 11. Then, the determination unit 12 determines the ICT knowledge level of the user, based on the proficiency level information. In one example, the ICT knowledge level is determined, based on an evaluation value of the user described above. In another example, the ICT knowledge level is determined according to whether the user satisfies one or a plurality of predetermined conditions. For example, one of the predetermined conditions is that a cumulative time during which the user uses the ICT use environment exceeds a threshold. Another one of the predetermined conditions is that the user has completed a specific ICT-related course by a preceding period.

Alternatively, the determination unit 12 may determine the ICT knowledge level of the user, in consideration of information input from outside (for example, research contents, research achievements, presentations in academic conferences, evaluation from instructor, other self-reported results of user), in addition to the acquired proficiency level information. Alternatively, the determination unit 12 may acquire a course record of an AI education course of the user from the education affairs system 300 (FIG. 1) or the learning management system (FIG. 1) in cooperation with the ICT education support device 10 and determine the ICT knowledge level of the user, based on a completion status of the AI education course of the user.

The determination unit 12 stores the information indicating the ICT knowledge level of the user in the user level information DB 400, in association with the account of the user and outputs a determination result of the ICT knowledge level of the user, to the provision unit 13.

The provision unit 13 provides the ICT use environment according to the ICT knowledge level of the user, to the user. The provision unit 13 is an example of provision means.

For example, the provision unit 13 acquires the determination result of the ICT knowledge level of the user, from the determination unit 12.

Then, the provision unit 13 generates (constructs) the ICT use environment (FIG. 1) including a tool and a function for the ICT use environment according to the ICT knowledge level of the user.

In one example, the tool and the function for the ICT use environment include a machine learning library, a deep learning framework, a Project Based Learning (PBL) teaching material, exercise data, and a data analysis platform. In addition, use of academic research data in the university may be provided to the user of the ICT use environment, within a scope of permission of a researcher.

Then, the provision unit 13 provides the ICT use environment according to the ICT knowledge level of the user to the user’s terminal 100, by connecting an ICT use environment exclusively constructed for the user with the user’s terminal 100.

Alternatively, the provision unit 13 may determine the ICT use environment to be provided to the user, based on a learning attitude of the user (for example, attendance rate to lecture, the number of times of questions or presentations, and the number of report submissions), in addition to the ICT knowledge level of the user. The provision unit 13 can acquire information regarding the learning attitude of the user, from the user’s terminal 100 (FIG. 1), the education affairs system 300 (FIG. 1), or the like. Alternatively, the provision unit 13 may improve a degree of freedom of use of the tool and the function for the ICT use environment, for example, increasing the number of tokens that can be used by the user with generative AI, according to the ICT knowledge level of the user.

The transmission unit 14 transmits data to be submitted created by the user to an educational institution, in the ICT use environment provided to the user. The transmission unit 14 is an example of transmission means.

For example, the transmission unit 14 acquires the data to be submitted created by the user, using the ICT use environment generated (constructed) by the provision unit 13. Here, the data to be submitted includes documents, data analysis results, images, voice, program codes, graduation thesis, and various other reports. The user may be able to designate the data to be submitted.

The transmission unit 14 transmits the data to be submitted acquired from the ICT use environment, to the educational institution. The transmission method at this time is not particularly limited. For example, the transmission unit 14 uploads the data to be submitted, to a data server of the educational institution. In another example, the transmission unit 14 attaches the data to be submitted to an e-mail and transmits the e-mail to a mail address of the educational institution.

A teacher belonging to the educational institution accesses the system of the educational institution, using the teacher account, using the teacher terminal 200 (FIG. 1) owned by the teacher and refers to the data to be submitted received from the transmission unit 14 by the system of the educational institution. In this way, the teacher can remotely receive the report or the like from the user (student).

### Operation of ICT Education Support Device 10

An operation of the ICT education support device 10 according to the first example embodiment will be described, with reference to FIG. 3. FIG. 3 is a flowchart illustrating the operation of the ICT education support device 10.

As illustrated in FIG. 3, first, the acquisition unit 11 acquires the information according to the proficiency level about the ICT of the user of the ICT use environment, from the user’s terminal 100 (FIG. 1) or the education affairs system 300 (FIG. 1) (S101).

Next, the determination unit 12 determines the ICT knowledge level (literacy level) of the user, using the proficiency level information acquired by the acquisition unit 11 (S102).

The provision unit 13 constructs the ICT use environment according to the ICT knowledge level of the user, based on the determination result by the determination unit 12 and provides the constructed ICT use environment to the user (S103).

The transmission unit 14 transmits the data to be submitted created by the user to the educational institution, in the ICT use environment provided by the provision unit 13 to the user (S104).

As described above, the operation of the ICT education support device 10 according to the first example embodiment ends.

### Effects of Present Example Embodiment

According to the configuration of the present example embodiment, the acquisition unit 11 acquires the information according to the proficiency level about the ICT of the user of the ICT use environment. The determination unit 12 determines the ICT knowledge level of the user, using the acquired proficiency level information. The provision unit 13 provides the ICT use environment according to the ICT knowledge level of the user, to the user. The transmission unit 14 transmits data to be submitted created by the user to an educational institution, in the ICT use environment provided to the user.

In this way, since it is possible to provide the ICT use environment according to the ICT knowledge level of the user (student or the like) of the educational service, a learning efficiency and an understanding degree of the user can be effectively improved. By providing the ICT use environment according to the ICT knowledge level of the user to the user, the educational institution (university or the like) can highlight its high AI education capabilities. Therefore, the educational institution can enhance competitiveness for securing students.

### Second Example Embodiment

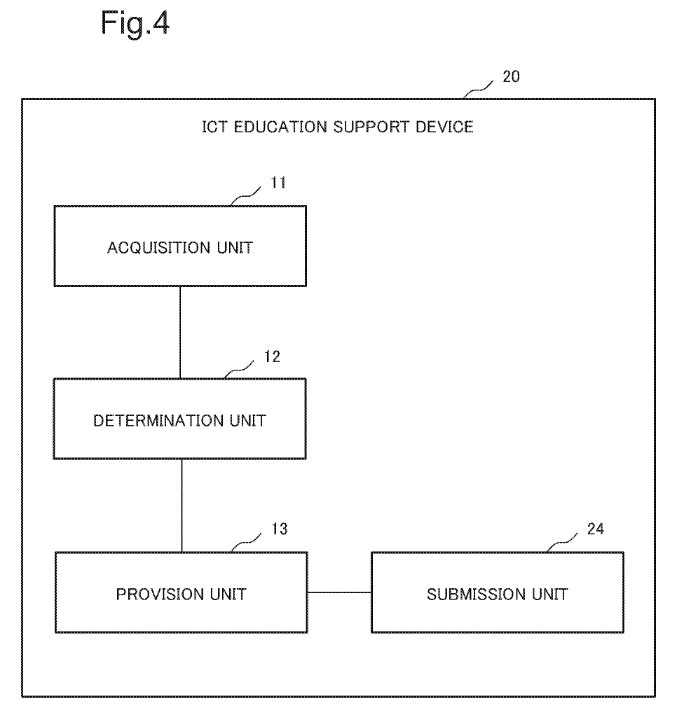

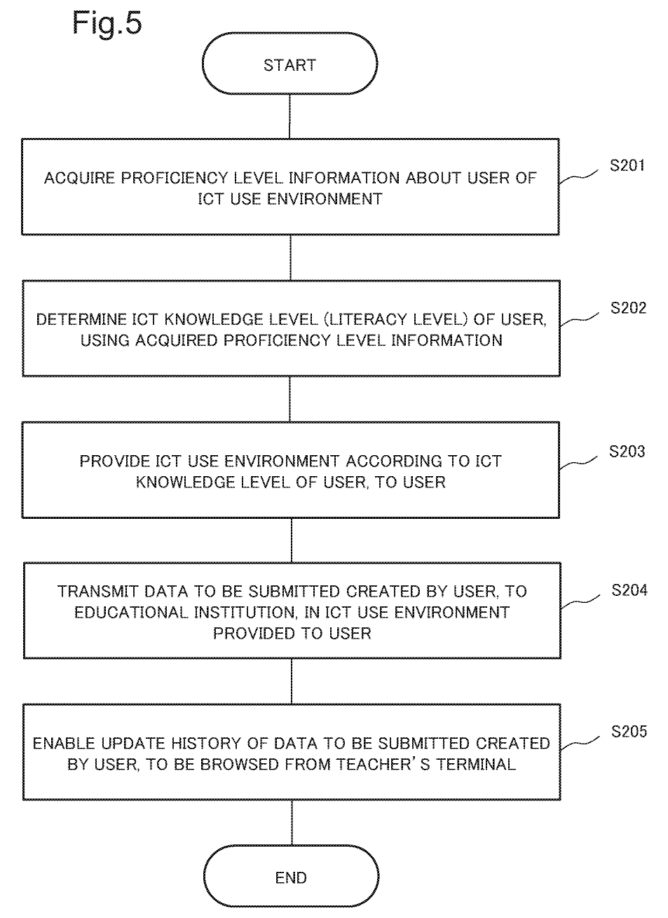

A second example embodiment will be described with reference to FIGS. 4 and 5. In the second example embodiment, a configuration will be described in which data to be submitted created by a user can be browsed from a terminal 200 (FIG. 1) of a teacher belonging to an educational institution.

In the second example embodiment, a component having the same function as that in the first example embodiment is denoted with the same reference numeral.

### Configuration of ICT Education Support Device 20

FIG. 4 is a block diagram illustrating a configuration of an ICT education support device 20 according to the second example embodiment. As illustrated in FIG. 4, the ICT education support device 20 includes an acquisition unit 11, a determination unit 12, a provision unit 13, and a transmission unit 24.

The acquisition unit 11 acquires information according to a proficiency level about an ICT of a user of an ICT use environment, from a user’s terminal 100 (FIG. 1) or an education affairs system 300 (FIG. 1).

The acquisition unit 11 outputs the acquired proficiency level information to the determination unit 12.

The determination unit 12 determines an ICT knowledge level (literacy level) of the user, using the proficiency level information.

The determination unit 12 stores the information indicating the ICT knowledge level of the user in the user level information DB 400, in association with the account of the user and outputs a determination result of the ICT knowledge level of the user, to the provision unit 13.

The provision unit 13 provides the ICT use environment according to the ICT knowledge level of the user to the user’s terminal 100, by connecting an ICT use environment exclusively constructed for the user with the user’s terminal 100.

The transmission unit 24 transmits the data to be submitted created by the user to the educational institution, in the ICT use environment provided to the user. The transmission unit 24 is an example of transmission means.

For example, the transmission unit 24 acquires the data to be submitted created by the user, using the ICT use environment generated (constructed) by the provision unit 13. Then, the transmission unit 24 transmits the data to be submitted acquired from the ICT use environment to the educational institution, by any means.

Moreover, the transmission unit 24 enables the data to be submitted created by the user to be browsed from the terminal 200 (FIG. 1) of the teacher belonging to the educational institution.

As a result, the teacher belonging to the educational institution can access the ICT use environment of the user, using the teacher terminal 200 (FIG. 1) owned by the teacher and easily confirm whether the data to be submitted created by the user is updated. If the data to be submitted created by the user is updated, the teacher can refer to an update history of the data to be submitted and easily grasp updated content.

### Operation of ICT Education Support Device 20

An operation of the ICT education support device 20 according to the second example embodiment will be described with reference to FIG. 5. FIG. 5 is a flowchart illustrating the operation of the ICT education support device 20.

As illustrated in FIG. 5, first, the acquisition unit 11 acquires identification information of the user from the user’s terminal 100 (FIG. 1) and acquires the proficiency level information stored in the system 300 (FIG. 1) of the educational institution (S201).

Next, the determination unit 12 determines the ICT knowledge level (literacy level) of the user, using the proficiency level information (S202).

Subsequently, the provision unit 13 acquires a tool and a function for the ICT use environment according to the ICT knowledge level of the user and generates (construct) the ICT use environment for the user, using the acquired tool and function.

Then, the provision unit 13 provides the ICT use environment according to the ICT knowledge level of the user to the user (S203).

The transmission unit 24 transmits the data to be submitted created by the user to the educational institution, in the ICT use environment provided to the user (S204). The transmission unit 24 enables the update history of the data to be submitted created by the user to be browsed from the terminal 200 (FIG. 1) of the teacher belonging to the educational institution (S205).

As described above, the operation of the ICT education support device 20 according to the second example embodiment ends

### Effects of Present Example Embodiment

According to the configuration of the present example embodiment, the acquisition unit 11 acquires the information according to the proficiency level about the ICT of the user of the ICT use environment. The determination unit 12 determines the ICT knowledge level of the user, using the acquired proficiency level information. The provision unit 13 provides the ICT use environment according to the ICT knowledge level of the user, to the user. The transmission unit 24 transmits the data to be submitted created by the user to the educational institution, in the ICT use environment provided to the user.

In this way, since it is possible to provide the ICT use environment according to the ICT knowledge level of the user (student or the like) of the educational service, a learning efficiency and an understanding degree of the user can be effectively improved. By providing the ICT use environment according to the ICT knowledge level of the user to the user, the educational institution (university or the like) can highlight its high AI education capabilities. Therefore, the educational institution can enhance competitiveness for securing students.

Moreover, according to the configuration of the present example embodiment, the transmission unit 24 enables the update history of the data to be submitted created by the user to be browsed from the terminal 200 of the teacher belonging to the educational institution. This eliminates need for the user to directly submit a report or an assignment to the teacher. The teacher can confirm content of the data to be submitted created by the user anywhere, using the teacher terminal 200, without going to a school or the like. In addition, in order to grasp a progress of a graduation thesis of the user, the teacher can access the ICT use environment of the user from the teacher terminal 200 and browse an update history of the graduation thesis of the user.

### Example of Hardware Configuration

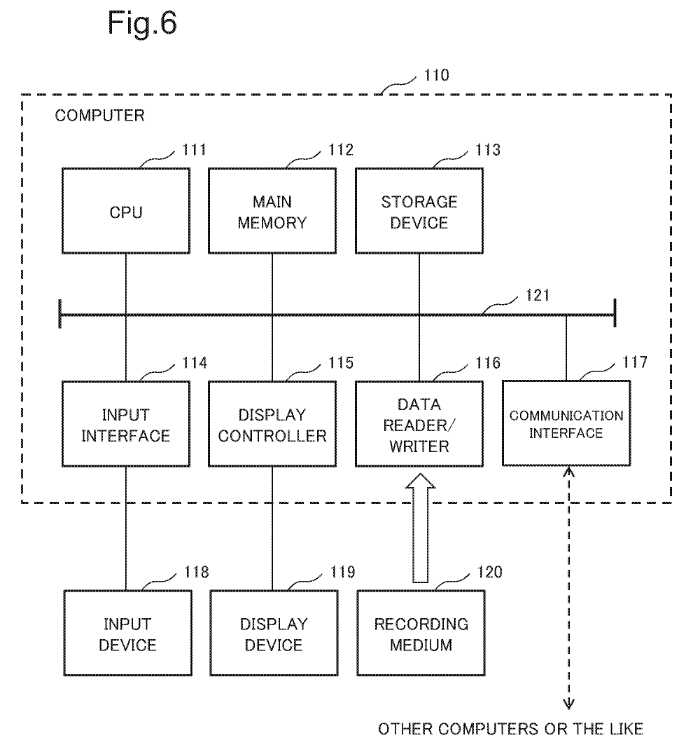

Each component of the ICT education support devices 10 and 20 described in the first and second example embodiments represents a block of a functional unit. Some or all of these components are achieved by, for example, an information processing device as illustrated in FIG. 6. FIG. 6 is a block diagram illustrating an example of a hardware configuration of the information processing device.

As illustrated in FIG. 6, a computer 110 includes a Central Processing Unit (CPU) 111, a main memory 112, a storage device 113, an input interface 114, a display controller 115, a data reader/writer 116, and a communication interface 117. These units are connected via a bus 121 in such a way as to be able to perform data communication with each other. The computer 110 may include a Graphics Processing Unit (GPU) or a Field-Programmable Gate Array (FPGA) in addition to the CPU 111 or instead of the CPU 111.

The CPU 111 loads programs (codes) in the present example embodiment, which are stored in the storage device 113, into the main memory 112, and executes them in a predetermined order to perform various operations. The main memory 112 is typically a volatile storage device such as a Dynamic Random Access Memory (DRAM). The programs in the present example embodiment are provided in a state of being stored in a computer-readable recording medium 120. The programs in the present example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard or a mouse. The display controller 115 is connected to a display device 119, and controls display on the display device 119.

The data reader/writer 116 mediates data transmission between the CPU 111 and the recording medium 120, reads a program from the recording medium 120, and writes a processing result of the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a flexible disk, and an optical recording medium such as a compact disk read only memory (CD-ROM).

### Supplementary Note

Some or all of the above example embodiments may be described as the following Supplementary Notes, but are not limited to the following.

### Supplementary Note 1

An ICT education support device including:
acquisition means for acquiring information according to a proficiency level about an ICT of a user of an ICT use environment;
determination means for determining an ICT knowledge level of the user, using the acquired information;
provision means for providing the ICT use environment according to the ICT knowledge level of the user to the user; and
transmission means for transmitting data to be submitted created by the user to an educational institution, in the ICT use environment provided to the user.

### Supplementary Note 2

The ICT education support device according to supplementary note 1, in which
the determination means determines the ICT knowledge level of the user, in consideration of information input from outside (for example, research achievements, presentations in academic conferences, and self-report of user), in addition to the acquired information.

### Supplementary Note 3

The ICT education support device according to supplementary note 1, in which
the provision means determines the ICT use environment to be provided to the user, based on a learning attitude of the user, in addition to the ICT knowledge level of the user.

### Supplementary Note 4

The ICT education support device according to supplementary note 1, in which
the transmission means enables an update history of the data to be submitted created by the user to be browsed from a terminal of a teacher belonging to the educational institution.

### Supplementary Note 5

The ICT education support device according to supplementary note 1, in which
the information includes information indicating a completion status of an ICT-related course of the user.

### Supplementary Note 6

The ICT education support device according to supplementary note 1, in which
the information includes information indicating learning evaluation of the user in an ICT-related course.

### Supplementary Note 7

The ICT education support device according to supplementary note 1, in which
the information includes a use time of the ICT use environment by the user.

### Supplementary Note 8

The ICT education support device according to supplementary note 1, in which
the information includes an access log of the user to the ICT use environment.

### Supplementary Note 9

An ICT education support method executed by a computer, including:
a process for acquiring information according to a proficiency level about an ICT of a user of an ICT use environment;
a process for determining an ICT knowledge level of the user, using the acquired information;
a process for providing the ICT use environment according to the ICT knowledge level of the user to the user; and
a process for transmitting data to be submitted created by the user to an educational institution, in the ICT use environment provided to the user.

### Supplementary Note 10

A program for causing a computer to execute:
processing for acquiring information according to a proficiency level about an ICT of a user of an ICT use environment;
processing for determining an ICT knowledge level of the user, using the acquired information;
processing for providing the ICT use environment according to the ICT knowledge level of the user to the user; and
processing for transmitting data to be submitted created by the user to an educational institution, in the ICT use environment provided to the user.

Some or all of the configurations described in Supplementary Notes 2 to 8 dependent on Supplementary Note 1 described above (ex. ICT education support device) can also be dependent on Supplementary Note 9 (ex. ICT education support method) and Supplementary Note 10 (ex. program) by the same dependency relationship as Supplementary Notes 2 to 8. Some or all of the configurations described as Supplementary Notes can be similarly dependent on various hardware, software, recording means for recording software, or systems without departing from the above-described example embodiments.

While the present disclosure has been particularly shown and described with reference to example embodiments thereof, the present disclosure is not limited to these example embodiments. Each example embodiment can be appropriately combined with other embodiments. It will be understood by those of ordinary skill in the art that various changes in form and details may be made therein without departing from the spirit and scope of the present disclosure as defined by the claims.

The present disclosure can be used to support AI education in the education industry, for example.

This application is based upon and claims the benefit of priority from Japanese patent application No. 2025-054981, filed on Mar. 28, 2025, the disclosure of which is incorporated herein in its entirety by reference.

1. An ICT education support device comprising:
a memory configured to store instructions; and
at least one processor configured to execute the instructions to perform:
acquiring information according to a proficiency level about an ICT of a user of an ICT use environment;
determining an ICT knowledge level of the user, using the acquired information;
providing the ICT use environment according to the ICT knowledge level of the user to the user; and
transmitting data to be submitted created by the user to an educational institution, in the ICT use environment provided to the user.

2. The ICT education support device according to claim 1, wherein
the at least one processor is configured to execute the instructions to perform:
determining the ICT knowledge level of the user, in consideration of information input from outside, in addition to the acquired information.

3. The ICT education support device according to claim 1, wherein
the at least one processor is configured to execute the instructions to perform:
determining the ICT use environment to be provided to the user, based on a learning attitude of the user, in addition to the ICT knowledge level of the user.

4. The ICT education support device according to claim 1, wherein
the at least one processor is configured to enable an update history of the data to be submitted created by the user to be browsed from a terminal of a teacher belonging to the educational institution.

5. The ICT education support device according to claim 1, wherein
the information includes information indicating a completion status of an ICT-related course of the user.

6. The ICT education support device according to claim 1, wherein
the information includes information indicating learning evaluation of the user in an ICT-related course.

7. The ICT education support device according to claim 1, wherein
the information includes a use time of the ICT use environment by the user.

8. The ICT education support device according to claim 1, wherein
the information includes an access log of the user to the ICT use environment.

9. The ICT education support device according to claim 1, wherein
the at least one processor is configured to execute the instructions to perform:
determining the ICT knowledge level of the user includes using a machine learning model trained based on proficiency information of a plurality of users.

10. The ICT education support device according to claim 1, wherein
the at least one processor is further configured to execute the instructions to perform:
making an update history of the submission data created by the user viewable from a terminal of an instructor belonging to the educational institution, to support the instructor's decision making on a guidance policy for the user.

11. An ICT education support method executed by a computer, comprising:
a process for acquiring information according to a proficiency level about an ICT of a user of an ICT use environment;
a process for determining an ICT knowledge level of the user, using the acquired information;
a process for providing the ICT use environment according to the ICT knowledge level of the user to the user; and
a process for transmitting data to be submitted created by the user to an educational institution, in the ICT use environment provided to the user.

12. A non-transitory recording medium storing a program for causing a computer to execute:
processing for acquiring information according to a proficiency level about an ICT of a user of an ICT use environment;
processing for determining an ICT knowledge level of the user, using the acquired information;
processing for providing the ICT use environment according to the ICT knowledge level of the user to the user; and
processing for transmitting data to be submitted created by the user to an educational institution, in the ICT use environment provided to the user.
